(19) United States
(12) Patent Application Publication
(10) Pub. No.: US 2011/0236748 A1
(43) Pub. Date: Sep. 29, 2011

(54) CURRENT COLLECTOR FOR NON-AQUEOUS ELECTROLYTE SECONDARY BATTERY, ELECTRODE, NON-AQUEOUS ELECTROLYTE SECONDARY BATTERY, AND METHOD FOR PRODUCING THE SAME

(76) Inventors: Takuya Nakashima, Osaka (JP); Hiroshi Temmyo, Osaka (JP)

(21) Appl. No.: 13/132,806

(22) PCT Filed: Aug. 20, 2010
(86) PCT No.: PCT/JP2010/005139

§ 371 Date: Jun. 3, 2011

(30) Foreign Application Priority Data
Oct. 26, 2009 (JP) 2009245622

(51) Int. Cl. H01M 4/74; H01M 2/02; H01M 4/04; B23K 26/38

(52) U.S. Cl. 429/163; 429/241; 29/623.1; 219/121.71

(57) ABSTRACT

A current collector includes a metal foil with a plurality of through-holes formed therein. The metal foil is divided into two regions of: a distant region distant from a connection portion to be connected to an external terminal; and a close region being close to the connection portion and having the same area as the distant region. The open area ratio of the distant region of the metal foil is larger than that of the close region. Thus, the electrical resistance of the close region is smaller than that of the distant region. Therefore, production of heat in the close region due to passage of current can be suppressed.

### TECHNICAL FIELD

This invention relates to non-aqueous electrolyte secondary batteries such as lithium ion secondary batteries, and particularly to an improvement in a current collector and an electrode for improving the cycle characteristics of a non-aqueous electrolyte secondary battery.

### BACKGROUND ART

Recently, lithium ion secondary batteries have been widely used as the power source for portable electronic devices and portable communications devices. Lithium ion secondary batteries use a material capable of absorbing and desorbing lithium, for example, a carbonaceous material, as a negative electrode active material. They use a composite oxide (lithium-containing composite oxide) including transition metal and lithium, such as LiCoO₂ (lithium cobaltate), as a positive electrode active material. Lithium ion secondary batteries can realize battery characteristics of high voltage and high discharge capacity.

However, with electronic devices and communications devices increasingly becoming multi-functional, the battery characteristics of secondary batteries such as lithium ion secondary batteries need to be further improved. In particular, battery characteristics (capacity and voltage) which deteriorate due to repeated charge/discharge (hereinafter referred to as “cycle characteristics”) need to be further improved.

The cycle characteristics of lithium ion secondary batteries are briefly described below.

An electrode (positive or negative electrode), which is a power generating element of a lithium ion secondary battery, is usually produced as follows.

A positive electrode active material or a negative electrode active material, a binder, and, if necessary, a conductive agent are dispersed in a dispersion medium to form an electrode mixture ink. The electrode mixture ink is applied onto one or both faces of a current collector and dried to form an active material layer or active material layers. The current collector with the active material layer(s) is pressed so that the total thickness reaches a predetermined thickness.

The battery performance of a secondary battery made with an electrode produced by such a process deteriorates with use. The main reason for such deterioration is a gradual decrease in the adhesion of the active material layer to the current collector. This causes the active material to fall off the current collector. The decrease in the adhesion of the active material layer to the current collector is caused by repeated expansion and contraction of the active material due to repeated charge/discharge.

Another reason for deterioration of battery performance of a non-aqueous electrolyte secondary battery with use is production of heat by the current collector due to passage of current. The production of heat by the current collector promotes deterioration of the adjacent active material and decomposition of the electrolyte. As a result, the battery performance deteriorates.

In connection therewith, PTL 1 proposes the following technique.

A current collector produces the largest amount of heat due to passage of current at the portion (current collection portion) to which a lead is attached and in which the current is concentrated. Thus, the thickness of the current collector is made the greatest at a part close to the current collection portion, while the thickness of the current collector is decreased as the distance from the current collection portion increases.

PTL 1 states that this allows minimization of the resistance of the current collector and the heat produced thereby.

### CITATION LIST

### Patent Literature

PTL 1: Japanese Laid-Open Patent Publication No. Hei 9-199177

### SUMMARY OF INVENTION

### Technical Problem

Lithium ion secondary batteries may use a metal foil (e.g., copper foil or aluminum foil) having a thickness of approximately 5 to 15 μm as a current collector. Such a very thin metal foil is very difficult to work so that its thickness changes gradually. Therefore, the technique of PTL 1 is actually very difficult to utilize, although it may be theoretically correct.

It is therefore an object of the invention to provide a current collector for a non-aqueous electrolyte secondary battery which can suppress heat production due to passage of current to improve the cycle characteristics of the non-aqueous electrolyte secondary battery and which can be produced easily, as well as an electrode and a non-aqueous electrolyte secondary battery which use such a current collector, and methods for producing the same.

### Solution to Problem

The invention provides a current collector for a non-aqueous electrolyte secondary battery. The current collector includes a metal foil with a plurality of through-holes, and the metal foil has a current collection region where an electrode active material is supported and a connection portion to be connected to an external terminal. The current collection region is divided into two regions of: (i) a distant region distant from the connection portion; and (ii) a close region being close to the connection portion and having the same area as the distant region. The through-holes are distributed so that the open area ratio of the distant region is larger than that of the close region.

The invention also provides a method for producing a current collector for a non-aqueous electrolyte secondary battery, including the steps of: (a) preparing a metal foil having a current collection region where an electrode active material is supported and a connection portion to be connected to an external terminal; and (b) forming a plurality of through-holes in the metal foil. The step (b) includes distributing the through-holes in the metal foil, which is divided in two regions of: (i) a distant region distant from the connection portion; and (ii) a close region being close to the connection portion and having the same area as the distant region, in such a manner that the open area ratio of the distant region is larger than that of the close region.

### Advantageous Effects of Invention

According to the invention, the open area ratio of the distant region of the metal foil is larger than that of the close region. Thus, the electrical resistance of the close region is smaller than that of the distant region. As a result, the difference in current density between the distant region and the close region is decreased. It is thus possible to decrease the difference in the amount of heat produced between the distant region and the close region and make the amounts of heat produced in the respective parts of the current collector due to passage of current uniform.

This can prevent promotion of deterioration of the active material in a specific part of the current collector, in particular, in a region close to the portion to be connected to the external terminal and prevent promotion of decomposition of the electrolyte. Therefore, the cycle characteristics of the non-aqueous electrolyte secondary battery can be improved.

### BRIEF DESCRIPTION OF DRAWINGS

FIG. 1 is a schematic plan view of the structure of a current collector for a non-aqueous electrolyte secondary battery according to one embodiment of the invention;

FIG. 2 is a schematic plan view of the structure of a current collector for a non-aqueous electrolyte secondary battery according to another embodiment of the invention;

FIG. 3 is a schematic plan view of the structure of a current collector for a non-aqueous electrolyte secondary battery according to still another embodiment of the invention; and

FIG. 4 is a schematic longitudinal sectional view of the structure of a non-aqueous electrolyte secondary battery according to one embodiment of the invention.

### DESCRIPTION OF EMBODIMENTS

The current collector of the invention is a current collector for a non-aqueous electrolyte secondary battery, and includes a metal foil with a plurality of through-holes. The metal foil has a current collection region where an electrode active material is supported and a connection portion to be connected to an external terminal. The current collection region is divided into two regions of: (i) a distant region distant from the connection portion; and (ii) a close region being close to the connection portion and having the same area as the distant region. The through-holes are distributed so that the open area ratio of the distant region is larger than that of the close region.

When the secondary battery is discharged, a current flows through the current collector due to electromotive force of the electrode active material in the respective parts of the current collection region. Thus, the absolute amount of current is larger in the close region than the distant region. Since the open area ratio of the distant region is larger than that of the close region, the effective cross sectional area of the conductive paths from the respective parts of the current collection region to the connection portion is larger in the close region than the distant region. Therefore, the difference between the current density of the close region and the current density of the distant region can be decreased. Due to the same reason, when the secondary battery is charged, the difference between the current density of the close region and the current density of the distant region can be decreased.

In the current collector in one embodiment of the invention, the metal foil has a rectangular shape with a pair of long-side ends and a pair of short-side ends, and the connection portion is disposed along one of the long-side ends. The current collection region is divided in two so that the border between the close region and the distant region is a straight line parallel to the long-side ends. As used herein, a pair of long-side ends refers to a pair of long sides of the rectangular metal foil. A pair of short-side ends as used herein refers to a pair of short sides of the rectangular metal foil.

In the current collector in another embodiment of the invention, the metal foil has a rectangular shape with a pair of long-side ends and a pair of short-side ends, and the connection portion is disposed along one of the short-side ends. The current collection region is divided in two so that the border between the close region and the distant region is a straight line parallel to the short-side ends.

In the current collector in still another embodiment of the invention, the metal foil has a rectangular shape with a pair of long-side ends and a pair of short-side ends, and the connection portion is disposed at a position that is away from each of the short-side ends for a predetermined distance. The current collection region is divided in two so that the border between the close region and the distant region is a straight line parallel to the short-side direction.

The ratio A/B of the open area ratio A of the close region to the open area ratio B of the distant region is preferably in the range of 0.1 to 0.8. If A/B is smaller than 0.1, the open area ratio B of the distant region may become too large, which may result in a decrease in the strength of the current collector. If A/B is larger than 0.8, the difference between A and B is too small, and it may be difficult to sufficiently decrease the difference in current density.

Further, the through-holes preferably have a size of 0.01 to 5 mm. If the size of the through-holes exceeds 5 mm, the strength of the current collector may decrease significantly. If the size of the through-holes is less than 0.01 mm, a very large number of through-holes are necessary to sufficiently decrease the difference in current density. Thus, the amount of workload in the process for forming the through-holes increases.

In the current collector in still another embodiment of the invention, the through-holes are distributed in the metal foil so that the open area ratio increases in proportion to the distance from the connection portion. By setting the distribution of the through-holes in the metal foil so that the open area ratio changes as described above, the current densities of the respective parts of the current collector can be made more uniform.

Further, the invention relates to an electrode for a non-aqueous electrolyte secondary battery, including: the above-mentioned current collector for a non-aqueous electrolyte secondary battery; and an electrode active material supported on one or both faces of the current collector.

In the electrode for a non-aqueous electrolyte secondary battery in one embodiment of the invention, electrode active material layers formed on both faces of the metal foil are joined via the through-holes. This makes it possible to suppress the electrode active material layers from falling off the current collector.

Further, the invention pertains to a non-aqueous electrolyte secondary battery including: an electrode assembly including a positive electrode, a negative electrode, and a separator interposed between the two electrodes, which are laminated or wound; a non-aqueous electrolyte; a battery case for housing the electrode assembly and the non-aqueous electrolyte, the battery case having an opening; and a seal member for sealing the opening. In the non-aqueous electrolyte secondary battery of the invention, at least one of the positive electrode and the negative electrode is the above-mentioned electrode for a non-aqueous electrolyte secondary battery.

Further, the invention includes the steps of: (a) preparing a metal foil having a current collection region where an electrode active material is supported and a connection portion to be connected to an external terminal; and (b) forming a plurality of through-holes in the metal foil. The step (b) includes distributing the through-holes in the metal foil, which is divided in two regions of: (i) a distant region distant from the connection portion; and (ii) a close region being close to the connection portion and having the same area as the distant region, in such a manner that the open area ratio of the distant region is larger than that of the close region.

The through-holes can be formed by at least one selected from the group consisting of press working, etching, and laser machining.

Embodiments of the invention are hereinafter described with reference to drawings.

### Embodiment 1

FIG. 1 is a schematic plan view of the structure of a current collector for a non-aqueous electrolyte secondary battery according to Embodiment 1 of the invention.

A current collector 10 illustrated therein comprises a metal foil 11 having a rectangular shape. The metal foil 11 has a plurality of through-holes 12 in a predetermined arrangement.

The current collector 10 has one end 13 in the width direction, to which an electrode lead (not shown) is attached. That is, the one end (long-side end) 13 of the current collector 10 in the width direction is a portion to be connected to an external terminal where the current is concentrated. The other portion of the current collector 10 is a current collection region 22 where an active material is supported. As used herein, a rectangular shape refers to a shape having a pair of long-side ends and a pair of short-side ends.

With respect to the arrangement of the through-holes 12, it is preferable to form the through-holes 12 in the current collection region 22 so that the open area ratio decreases toward the one end 13, which is the portion to be connected to the external terminal. As used herein, the open area ratio refers to, assuming that the current collection region 22 is divided into a predetermined number of equal regions in the width direction, the value obtained by dividing the open area of the through-holes 12 of each region by the area of the whole region. The border line between the regions is parallel to the long-side ends of the metal foil 11.

That is, the total open areas of the through-holes 12 in the respective regions are decreased toward the one end 13. For example, assume that the current collection region 22 is divided into two equal regions in the width direction of the current collector 10. In this case, the through-holes 12 are formed in the current collection region 22 so that the open area ratio of the region close to the one end 13 is smaller than that of the region distant from the one end 13. The ratio A/B of the open area ratio A of the region close to the one end 13 to the open area ratio B of the region distant from the one end 13 is preferably in the range of 0.1 to 0.8. In this case, it is possible to decrease the difference in current density between the two regions and decrease the amount of heat produced in the region close to the one end 13 due to passage of current.

In the example illustrated in FIG. 1, the current collection region 22 is divided into four equal regions in the width direction of the current collector 10, and the open area ratios in the four regions decrease toward the one end 13. Also, when the current collection region 22 is divided into two equal regions in the width direction, the region close to the one end 13 has a smaller open area ratio.

As described above, in the current collector 10 of the illustrated example, the through-holes 12 are formed in the current collection region 22 so that the open area ratio decreases toward the one end 13 in the width direction, which is the portion to be connected to the external terminal. Thus, the electrical resistance is relatively small in the part of the current collection region 22 close to the connection portion, whereas the electrical resistance is relatively large in the part distant from the connection portion.

As a result, when the current collector 10 is used to produce an electrode for a non-aqueous electrolyte secondary battery, and the non-aqueous electrolyte secondary battery is charged and discharged, the difference in current density in the respective parts of the current collection region 22 can be decreased. It is thus possible to decrease the difference in the amount of heat produced in the respective parts of the current collector 10.

It should be noted that the active material can be filled into the through-holes 12. Thus, even if the thickness of the whole current collector 10 is slightly increased, the amount of the active material inside the battery is not reduced. As such, the amount of heat produced in the part of the current collection region 22 close to the connection portion can be reduced without deteriorating the battery performance. It is thus possible to prevent the active material and electrolyte in the part close to the connection portion from being heated strongly to promote deterioration of the active material or cause decomposition of the electrolyte. This makes it possible to suppress deterioration of battery performance of the non-aqueous electrolyte secondary battery and improve the cycle characteristics.

It is ideal to form the through-holes 12 so that the current densities of the respective parts of the current collection region 22 are equal. That is, it is desirable to form the through-holes 12 so that the resistance value of each part of the current collection region 22 is proportional to the distance from the one end 13, which is the connection portion. By setting the resistance values of the respective parts of the current collection region 22 in the above-described manner, the amount of heat produced due to passage of current can be made more uniform throughout the current collection region 22. As a result, the cycle characteristics of the non-aqueous electrolyte secondary battery can be improved more significantly.

The size, shape and area of the through-holes 12 are not particularly limited. Also, the through-holes 12 may have the same size, shape and area, or the through-holes 12 may have different size, shape and area. For example, it is also possible to make the density of the through-holes 12 in the current collection region 22 constant and increase the size of the through-holes 12 as the distance from the connection portion increases.

However, in consideration of the ease with which the large number of through-holes 12 are formed, it is preferable that all the through-holes 12 have the same size, shape and area. In this case, an increase in production cost can be suppressed.

The shape of the through-holes 12 is not particularly limited, and any shapes such as a triangle, a square, a rectangle, a rhombus, other parallelograms, a trapezoid, and polygons with five or more sides may be used. However, in order to minimize a decrease in the strength of the current collector 10 when the large number of through-holes 12 are formed in the current collection region 22, the through-holes 12 are preferably circular or oval. They are most preferably circular, in which case a decrease in the strength of the current collection region 22 can be suppressed.

The size (maximum size) of the through-holes 12 is preferably 0.01 to 5 mm. If the size of the through-holes 12 is more than 5 mm, the strength of the current collector 10 lowers significantly. If the size of the through-holes 12 is less than 0.01 mm, a very large number of through-holes 12 become necessary to obtain the desired effect. Thus, the amount of workload in the process for forming the through-holes 12 increases. As a result, the production cost increases. Thus, by setting the size of the through-holes 12 to 0.01 to 5 mm, it is possible to suppress an increase in the production cost of the current collector 10 while suppressing a decrease in the strength.

Also, in order to suppress a decrease in the strength caused by the formation of the through-holes 12, it is preferable to make the thickness D0 of the current collector 10 greater than that of a current collector having no through-holes 12. When the minimum thickness of the current collector having no through-holes 12 is designated as D1, the thickness D0 of the current collector 10 is desirably 120 to 600% of D1.

As described above, even when the thickness of the current collector 10 is made slightly greater than conventional thickness, since the active material can be held in the through-holes 12, deterioration of battery performance can be suppressed.

### Embodiment 2

Next, Embodiment 2 of the invention is described.

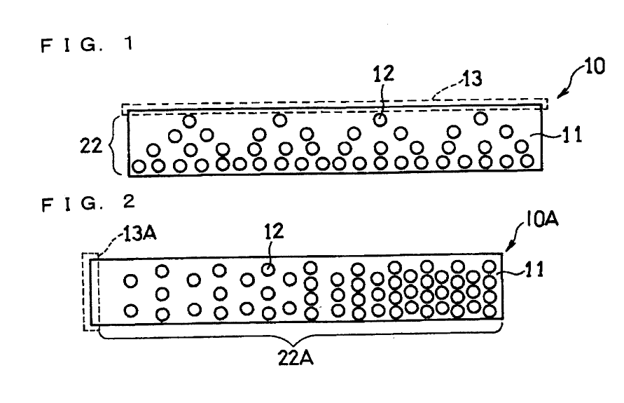

FIG. 2 is a schematic plan view of the structure of a current collector for a non-aqueous electrolyte secondary battery according to Embodiment 2. In FIG. 2, the same components as those of FIG. 1 are given the same reference characters.

A current collector 10A illustrated therein also comprises a rectangular metal foil 11 and the metal foil 11 has a plurality of through-holes 12, in the same manner as the current collector 10 of FIG. 1. The current collector 10A is different from the current collector 10 of FIG. 1 in that an electrode lead (not shown) is attached to one end (short-side end) 13A in the longitudinal direction. That is, the one end 13A of the current collector 10A in the longitudinal direction is the portion to be connected to an external terminal. The other portion of the current collector 10A is a current collection region 22A where an active material is supported.

In the current collector 10A, the open area ratio of the current collection region 22A also decreases toward the one end 13A, which is the connection portion. That is, assuming that the current collection region 22A is divided into a predetermined number (for example, two) of equal regions in the longitudinal direction of the current collector 10A, the closer to the one end 13A the region is, the smaller the open area ratio is. The border line between the regions is parallel to the short-side ends of the current collector 10A.

With the above configuration, even when the connection portion is formed at one end of the current collector in the longitudinal direction, essentially the same effect as that of Embodiment 1 can be achieved.

### Embodiment 3

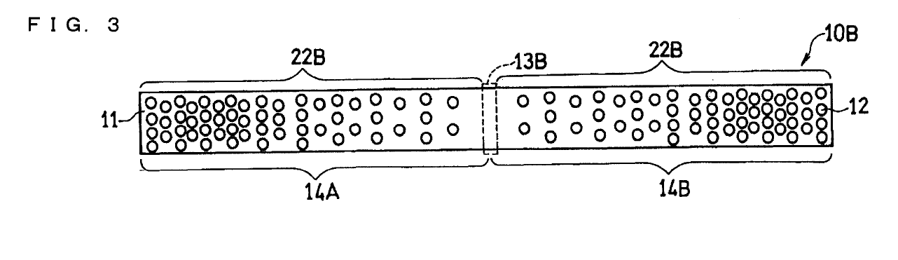

Next, Embodiment 3 of the invention is described. FIG. 3 is a schematic plan view of the structure of a current collector for a non-aqueous electrolyte secondary battery according to Embodiment 3. In FIG. 3, the same components as those of FIG. 1 are given the same reference characters.

A current collector 10B illustrated therein also comprises a metal foil 11 and the metal foil 11 has a plurality of through-holes 12, in the same manner as the current collector 10 of FIG. 1. The current collector 10B is different from the current collector 10 of FIG. 1 in that an electrode lead (not shown) is attached to a middle portion 13A in the longitudinal direction. That is, the middle portion 13B of the current collector 10B in the longitudinal direction is the portion to be connected to an external terminal. The other portion of the current collector 10B is a current collection region 22B where an active material is supported. In the current collector 10B, the current collection region 22B is divided in two by the middle portion 13B.

In the current collector 10B, the open area ratio of the current collection region 22B also decreases toward the middle portion 13B, which is the connection portion. That is, assume that the current collector 10B is divided at the center into two equal portions 14A and 14B, and that each current collection region 22B is divided into a predetermined number (for example, two) of equal regions in the longitudinal direction of the current collector 10B. The open area ratios of all these regions also decrease toward the middle portion 13B, which is the connection portion. The border line between the regions is parallel to the short-side ends of the current collector 10B.

Next, a description is given of an electrode for a non-aqueous electrolyte secondary battery which is produced by disposing a positive electrode active material or a negative electrode active material on a current collector.

When the electrode is a positive electrode, the material of the positive electrode current collector can be an aluminum foil or an aluminum alloy foil. The thickness thereof can be set to 5 μm to 30 μm. A positive electrode can be produced by applying a positive electrode mixture ink onto one or both faces of a positive electrode current collector with a die coater, drying it, and rolling it with a press until the total thickness reaches a predetermined thickness. The positive electrode mixture ink can be prepared by mixing and dispersing a positive electrode active material, a positive electrode conductive agent, and a positive electrode binder in a dispersion medium with a disperser such as a planetary mixer.

Examples of positive electrode active materials which can be used include lithium-containing transition metal oxides such as lithium cobaltate and modified lithium cobaltate (lithium cobaltate solid solutions with, for example, aluminum or magnesium dissolved therein), lithium nickelate and modified lithium nickelate (in which, for example, part of nickel is replaced with cobalt), and lithium manganate and modified lithium manganate.

Examples of positive electrode conductive agents which can be used include carbon blacks such as acetylene black, ketjen black, channel black, furnace black, lamp black, and thermal black and various graphites, and they can be used singly or in combination.

Examples of positive electrode binders which can be used include polyvinylidene fluoride (PVdF), modified polyvinylidene fluoride, polytetrafluoroethylene (PTFE), and rubber particles with an acrylate unit. The binder can contain an acrylate monomer or acrylate oligomer with a reactive functional group introduced therein.

When the electrode is a negative electrode, the material of the negative electrode current collector can be a rolled copper foil, an electrolytic copper foil, etc. The thickness thereof can be set to 5 μm to 30 μm. A negative electrode can be produced by applying a negative electrode mixture ink onto one or both faces of a negative electrode current collector with a die coater, drying it, and rolling it with a press until the total thickness reaches a predetermined thickness. The negative electrode mixture ink can be prepared by mixing and dispersing a negative electrode active material, a negative electrode binder, and, if necessary, a negative electrode conductive agent and a thickener in a dispersion medium with a disperser such as a planetary mixer.

Preferable negative electrode active materials which can be used include carbon materials such as graphite and alloyable materials. Examples of alloyable materials which can be used include silicon oxides, silicon, silicon alloys, tin oxides, tin, and tin alloys. Among them, silicon oxides are particularly preferable. Silicon oxides are desirably represented by the general formula SiOₓ where 0<x<2, preferably 0.01≦x≦1. In a silicon alloy, the other metal elements than silicon are desirably metal elements not alloyable with lithium, for example, titanium, copper, and nickel.

As the negative electrode binder, various binders including PVdF and modified PVdF can be used. In terms of improving lithium ion acceptance, it is also possible to use styrene-butadiene copolymer rubber particles (SBR) and modified SBR.

The thickener can be a material that is viscous in aqueous solution, such as polyethylene oxide (PEO) or polyvinyl alcohol (PVA), and is not particularly limited. However, in terms of dispersibility and viscosity of the electrode mixture ink, it is preferable to use cellulose resins such as carboxymethyl cellulose (CMC) and modified cellulose resins.

While the thickness of the active material layer differs according to the necessary characteristics of the non-aqueous electrolyte secondary battery to be produced, it is preferably in the range of 5 to 150 μm, and more preferably in the range of 10 to 120 μm.

Also, when an active material layer is formed on each side of the current collector, it is preferable to join the active material layer on one face of the current collector and the active material layer on the other face via the through-holes 12. This makes it possible to increase the bonding strength between the active material layer and the current collector. Thus, falling-off of the active material from the current collector can be suppressed. Therefore, the cycle characteristics of the non-aqueous electrolyte secondary battery can be improved.

Also, it is preferable to fill the active material into the through-holes 12. This can increase the amount of the active material which can be held in a battery case with a predetermined volume. Therefore, the battery performance of the non-aqueous electrolyte secondary battery can be improved. It should be noted that because the current collector has the through-holes 12, the active material is naturally filled into the through-holes 12 in the step of pressing the electrode to a predetermined thickness. As such, the battery performance can be improved without increasing the number of steps.

Next, a description is given of non-aqueous electrolyte secondary batteries made with the current collectors of Embodiments 1 to 3 for non-aqueous electrolyte secondary batteries.

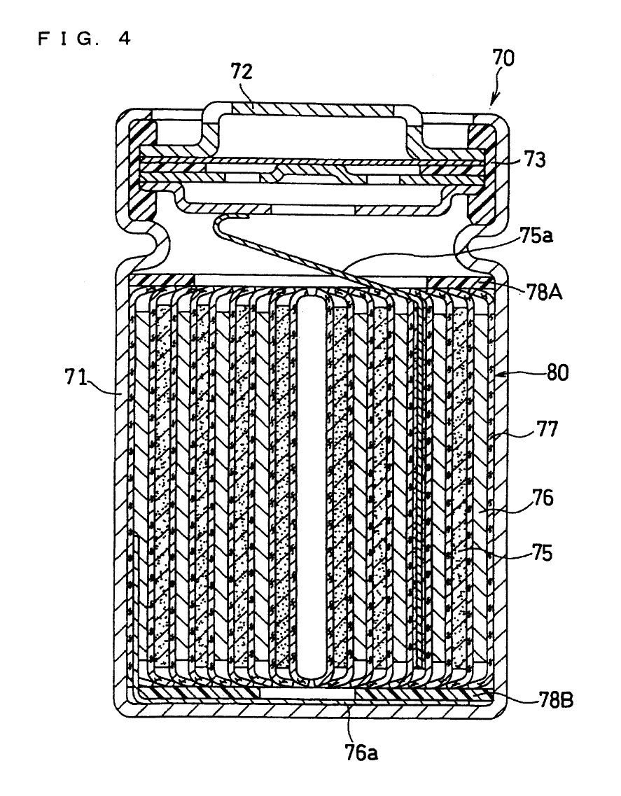

FIG. 4 illustrates an example of such non-aqueous electrolyte secondary batteries. A secondary battery 70 illustrated therein includes a positive electrode 75 comprising a positive electrode current collector and positive electrode active material layers formed thereon and a negative electrode 76 comprising a negative electrode current collector and negative electrode active material layers formed thereon. The positive electrode 75 and the negative electrode 76 with a separator 77 interposed therebetween are spirally wound to form an electrode assembly 80. A positive electrode lead 75a is attached to the positive electrode 75, while a negative electrode lead 76a is attached to the negative electrode 76.

The electrode assembly 80 fitted with upper and lower insulator plates 78A and 78B is placed in a cylindrical battery case 71 with a bottom. The negative electrode lead 76a drawn from the lower part of the electrode assembly 80 is connected to the bottom of the battery case 71. The positive electrode lead 75a drawn from the upper part of the electrode assembly 80 is connected to a seal member 72 for sealing the opening of the battery case 71. Also, a predetermined amount of a non-aqueous electrolyte (not shown) is injected into the battery case 71. The injection of the non-aqueous electrolyte is performed after the electrode assembly 80 is placed in the battery case 71. Upon completion of the non-aqueous electrolyte, the seal member 72 whose circumference is fitted with a seal gasket 73 is inserted in the opening of the battery case 71, and the opening of the battery case 71 is bent and crimped inward to produce the lithium ion secondary battery 70.

The separator 77 is not particularly limited if it has a composition capable of withstanding the use as the non-aqueous electrolyte secondary battery separator. Preferably, the separator 77 can comprise one or more microporous films made of an olefin resin such as polyethylene or polypropylene. The thickness of the separator 77 is not particularly limited. The preferable thickness of the separator 77 is 10 to 30 μm.

The non-aqueous electrolyte can use various lithium compounds such as LiPF₆ and LIBF₄ as electrolyte salts. Also, as the solvent, ethylene carbonate (EC), dimethyl carbonate (DMC), diethyl carbonate (DEC), and methyl ethyl carbonate (MEC) can be used singly or in combination. Also, in order to form a good coating film on the surface of the positive electrode 75 or the negative electrode 76, or to ensure stability during overcharge, it is preferable to add vinylene carbonate (VC), cyclohexyl benzene (CHB), or modified VC or CHB to the non-aqueous electrolyte.

An example according to Embodiments 1 to 3 is hereinafter described. The invention is not to be construed as being limited to the Example.

### EXAMPLE 1

A lithium ion secondary battery was produced as follows.

### (Preparation of Positive Electrode)

An aluminum foil with a thickness of 20 μm, a width of 50 mm, and a length of 600 mm was prepared as a material of the positive electrode current collector. The middle portion of the positive electrode current collector was used as the portion to be connected to an external terminal. In the arrangement illustrated in FIG. 3, a plurality of through-holes were formed in the positive electrode current collector. The through-holes had a circular shape and a diameter of 2 mm.

Assuming that the area from the middle portion to one end (e.g., the right end in the figure) of the positive electrode current collector in the longitudinal direction was divided into six equal regions, the through-holes were formed in the positive electrode current collector so that the open area ratios of these regions decreased toward the intermediated portion. That is, the open area ratio of the region adjacent and closest to the middle portion was set to 10%, while the open area ratio of the region farthest therefrom and adjacent to the one end was set to 60%. The open area ratios of the four regions between these two regions, from the region closest to the middle portion to the region farthest therefrom, were set to 20%, 30%, 40%, and 50%, respectively. Also, assuming that the area from the middle portion to the one end was divided into two equal regions in the longitudinal direction of the current collector, the ratio of the open area ratios of the two regions was 0.375.

Likewise, assuming that the area from the middle portion to the other end (e.g., the left end in the figure) of the positive electrode current collector in the longitudinal direction was divided into six equal regions, the through-holes were formed in the positive electrode current collector so that the open area ratios of these regions decreased toward the intermediated portion. That is, the open area ratio of the region adjacent and closest to the middle portion was set to 10%, while the open area ratio of the region farthest therefrom and adjacent to the one end was set to 60%. The open area ratios of the four regions between these two regions, from the region closest to the middle portion to the region farthest therefrom, were set to 20%, 30%, 40%, and 50%, respectively. Also, assuming that the area from the middle portion to the one end was divided into two equal regions in the longitudinal direction of the current collector, the ratio of the open area ratios of the two regions was 0.375.

Using the positive electrode current collector prepared in the above manner, a positive electrode was produced.

A lithium-containing composite oxide having a mean particle size of 0.8 μm and a composition represented by LiNi_{0.85}CO_{0.12}Al_{0.03}O₂ was used as a positive electrode active material. 5 parts by mass of the positive electrode active material was added to 100 parts by mass of N-methyl-2-pyrrolidone (NMP) serving as a dispersion medium, and was sufficiently stirred, mixed, and dispersed therein to prepare a positive electrode active material ink.

PVDF “#1320 (trade name)” of Kureha Corporation (N-methyl-2-pyrrolidone (NMP) solution containing 12% by mass of PVDF) was used as a positive electrode binder. 5 parts by mass (solid content) of PVDF was added to 100 parts by mass of NMP, and was sufficiently stirred, mixed, and dissolved therein to prepare a positive electrode binder ink.

Acetylene black with a mean particle size of 50 nm was used as a conductive agent. 5 parts by mass of acetylene black was added to 100 parts by mass of NMP, and was sufficiently stirred, mixed, and dispersed therein to prepare a conductive agent ink.

The positive electrode active material ink, the positive electrode binder ink, and the conductive agent ink were applied onto a surface of the positive electrode current collector excluding the middle portion, by using an ink jet coater. The application was performed a plurality of times to form an electrode mixture layer with a predetermined thickness. The resulting coating film was dried at 100° C. for 1 hour. The dried coating film was rolled with a roll press, so that a 40-μm thick positive electrode mixture layer was formed except the middle portion. Likewise, a positive electrode mixture layer was formed on the other surface. At this time, the positive electrode mixture layer was formed on the whole area of the other surface. An electrode lead was attached to the middle portion where the current collector was exposed.

### (Preparation of Negative Electrode)

A copper foil with a thickness of 15 μm, a width of 60 mm, and a length of 700 mm was used as a material of a negative electrode current collector. One end of the negative electrode current collector in the longitudinal direction was used as a connection portion. In the arrangement illustrated in FIG. 2, a plurality of through-holes were formed in the negative electrode current collector. The through-holes had a circular shape and a diameter of 2 mm.

Assuming that the current collection region of the negative electrode current collector was divided into six equal regions, the through-holes were formed in the negative electrode current collector so that the open area ratios of these regions decreased toward the one end. That is, the open area ratio of the region adjacent and closest to the one end of the negative electrode current collector was set to 10%, while the open area ratio of the region farthest therefrom and adjacent to the other end of the negative electrode current collector was set to 60%. The open area ratios of the four regions between these two regions, from the region closest to the one end to the region farthest therefrom, were set to 20%, 30%, 40%, and 50%, respectively. Also, assuming that the current collector was divided into two equal regions in the longitudinal direction, the ratio of the open area ratios of the two regions was 0.375.

Using the negative electrode current collector prepared in the above manner, a negative electrode was produced.

Artificial graphite with a mean particle size of 1 μm was used as a negative electrode active material. 5 parts by mass of artificial graphite was added to 100 parts by mass of deionized water serving as a dispersion medium, and was sufficiently stirred, mixed, and dispersed therein. Then, a suitable amount of a 1 mass % aqueous solution of carboxymethyl cellulose (CMC) was added thereto to prepare a negative electrode active material ink.

Styrene butadiene rubber (SBR) of JSR Corporation (aqueous dispersion with a solid content of 40 mass %) was used as a negative electrode binder. 1 part by mass of SBR was added to 100 parts by mass of deionized water, and was sufficiently stirred, mixed, and dispersed therein. Then, a suitable amount of a 1 mass % aqueous solution of carboxymethyl cellulose (CMC) was added thereto to prepare a negative electrode binder ink.

The negative electrode active material ink and the negative electrode binder ink were applied onto a surface of the negative electrode current collector excluding the one end, by using an ink jet coater 20. The application was performed a plurality of times to form an electrode mixture layer with a predetermined thickness. The resulting coating film was dried at 100° C. for 1 hour. The dried coating film was rolled with a roll press, so that a 50-μm thick negative electrode mixture layer was formed except the one end. Likewise, a negative electrode mixture layer was formed on the other surface. At this time, the negative electrode mixture layer was formed on the whole area of the other surface. An electrode lead was attached to the one end where the current collector was exposed.

### (Preparation of Electrolyte)

A non-aqueous electrolyte was prepared by dissolving lithium hexafluorophosphate (LiPF₆) at a concentration of 1 mol/L in a solvent mixture containing ethylene carbonate and methyl ethyl carbonate in a volume ratio of 1:3.

Thereafter, the positive electrode and the negative electrode were spirally wound with a separator interposed therebetween, to produce an electrode assembly. Using the produced electrode assembly and the electrolyte prepared in the above manner, 100 lithium ion secondary batteries illustrated in FIG. 4 were produced.

### COMPARATIVE EXAMPLE 1

In the same manner as in Example 1, 100 lithium ion secondary batteries were produced except that no through-holes were formed in the positive electrode current collector and the negative electrode current collector.

The 100 lithium ion secondary batteries of each of Example 1 and Comparative Example 1 were subjected to 300 charge/discharge cycles. In an environment of 20° C., they were charged to 4.2 V at a constant current of 0.7 C, charged to a cut-off voltage of 0.05 C at a constant voltage, and discharged to 2.5 V at a constant current of 0.2 C. The discharge capacity obtained was defined as the initial discharge capacity. Thereafter, with the discharge current value set to 1 C, the charge/discharge cycle was repeated.

As a result, in Example 1, the average value of the capacity retention rate was 93%, whereas in Comparative Example 1, the average value of the capacity retention rate was 81%. This has confirmed that the invention can significantly improve the cycle characteristics.

### INDUSTRIAL APPLICABILITY

In the current collector for a non-aqueous electrolyte secondary battery according to the invention, the difference in the amount of heat produced due to passage of current is small between the part close to the portion to be connected to an external terminal and the part distant therefrom. It is thus possible to suppress deterioration of the active material and decomposition of the electrolyte due to heat particularly near the connection portion. Therefore, the invention is advantageously applicable to non-aqueous electrolyte secondary batteries which are required to provide good cycle characteristics as the power source for portable devices.

### REFERENCE SIGNS LIST

10 CURRENT COLLECTOR
11 METAL FOIL
12 THROUGH-HOLE
70 SECONDARY BATTERY

1. A current collector for a non-aqueous electrolyte secondary battery,
the current collector comprising a metal foil with a plurality of through-holes,
the metal foil having a current collection region where an electrode active material is supported and a connection portion to be connected to an external terminal,
the current collection region being divided into two regions of:
(i) a distant region distant from the connection portion; and
(ii) a close region being close to the connection portion and having the same area as the distant region, and
the through-holes being distributed so that the open area ratio of the distant region is larger than that of the close region.

2. The current collector in accordance with claim 1,
wherein the metal foil has a rectangular shape with a pair of long-side ends and a pair of short-side ends,
the connection portion is disposed along one of the long-side ends, and
the current collection region is divided in two so that a border between the close region and the distant region is a straight line parallel to the long-side ends.

3. The current collector in accordance with claim 1,
wherein the metal foil has a rectangular shape with a pair of long-side ends and a pair of short-side ends,
the connection portion is disposed along one of the short-side ends, and
the current collection region is divided in two so that a border between the close region and the distant region is a straight line parallel to the short-side ends.

4. The current collector in accordance with claim 1,
wherein the metal foil has a rectangular shape with a pair of long-side ends and a pair of short-side ends,
the connection portion is disposed at a position that is away from each of the short-side ends for a predetermined distance, and
the current collection region is divided in two so that a border between the close region and the distant region is a straight line parallel to the short-side direction.

5. The current collector in accordance with claim 1, wherein the ratio A/B of the open area ratio A of the close region to the open area ratio B of the distant region is in the range of 0.1 to 0.8.

6. The current collector in accordance with claim 1, wherein the through-holes have a size of 0.01 to 5 mm.

7. The current collector in accordance with claim 1, wherein the through-holes are distributed in the metal foil so that the open area ratio increases in proportion to the distance from the connection portion.

8. An electrode for a non-aqueous electrolyte secondary battery, comprising:
the current collector of claim 1 for a non-aqueous electrolyte secondary battery; and
an electrode active material supported on one or both faces of the current collector.

9. The electrode for a non-aqueous electrolyte secondary battery in accordance with claim 8, wherein electrode active material layers formed on both faces of the metal foil are joined via the through-holes.

10. A non-aqueous electrolyte secondary battery comprising:
an electrode assembly comprising a positive electrode, a negative electrode, and a separator interposed between the two electrodes, which are laminated or wound;
a non-aqueous electrolyte;
a battery case for housing the electrode assembly and the non-aqueous electrolyte, the battery case having an opening; and
a seal member for sealing the opening,
wherein at least one of the positive electrode and the negative electrode is the electrode of claim 8 or 9 for a non-aqueous electrolyte secondary battery.

11. A method for producing a current collector for a non-aqueous electrolyte secondary battery, comprising the steps of:
(a) preparing a metal foil having a current collection region where an electrode active material is supported and a connection portion to be connected to an external terminal; and
(b) forming a plurality of through-holes in the metal foil,
wherein the step (b) includes distributing the through-holes in the metal foil, which is divided in two regions of: (i) a distant region distant from the connection portion; and (ii) a close region being close to the connection portion and having the same area as the distant region, in such a manner that the open area ratio of the distant region is larger than that of the close region.

12. The method for producing a current collector for a non-aqueous electrolyte secondary battery in accordance with claim 11, wherein the through-holes are formed by at least one selected from the group consisting of press working, etching, and laser machining.
